(19) United States
(12) Patent Application Publication
(10) Pub. No.: US 2016/0266892 A1
(43) Pub. Date: Sep. 15, 2016

(54) PATCHING OF VIRTUAL MACHINES DURING DATA RECOVERY

(71) Applicant: HEWLETT PACKARD ENTERPRISE DEVELOPMENT LP, Houston, TX (US)

(72) Inventors: Bharath SN, Bangalore (IN); Shishir Misra, Bangalore (IN); Sahana Sampige Prabhakar, Bangalore (IN)

(21) Appl. No.: 15/033,527

(22) PCT Filed: Dec. 18, 2013
(86) PCT No.: PCT/US2013/075904

§ 371 Date: Apr. 29, 2016

(51) Int. Cl. G06F 9/445; G06F 9/455; G06F 11/14; G06F 3/06

(52) U.S. Cl. CPC G06F 8/65; G06F 3/0619; G06F 3/065; G06F 3/0664; G06F 3/067; G06F 9/45558; G06F 11/1469; G06F 2009/4557; G06F 2201/815

(57) ABSTRACT

Example embodiments relate to patching of virtual machines during data recovery. An example method includes receiving an indication that a virtual machine is to be restored to a system. The method may include causing a virtual machine image file for the virtual machine to be sent to the system. The virtual machine image file may be retrieved from a data backup repository. The method may include indicating to the system, to a disk mounting tool of the system, that the virtual machine image file is to be mounted to create a mounted version of the virtual machine. The method may include indicating to the system that the mounted version of the virtual machine is to be patched. The method may include receiving an indication from the system that the patching is complete. The method may include sending to the system an indication that the virtual machine can be brought online.

### BACKGROUND

Virtualization, in computing, refers to the act of creating a virtual, rather than actual, version of something, for example, a virtual computer hardware platform, operating system (OS), storage device, or computer network resource. The virtual version is typically implemented as software, whereas the actual version typically includes hardware. A virtual machine (VM) is a virtual version of a computing device (e.g., a physical machine). The VM emulates computer architecture that may be found in such a computing device, and the VM is capable of performing many or all of the tasks that the computing device may perform, for example, executing programs.

### BRIEF DESCRIPTION OF THE DRAWINGS

The following detailed description references the drawings, wherein:

FIG. 1 is a block diagram of an example computing environment in which patching of virtual machines during data recovery may be useful;

FIG. 2 is a block diagram of an example computing environment in which patching of virtual machines during data recovery may be useful;

FIGS. 3A, 3B, 3C are flowcharts of example methods for patching of virtual machines during data recovery;

FIG. 4 is a flowchart of an example method for patching of virtual machines during data recovery;

FIG. 5 is a flowchart of an example method for patching of virtual machines during data recovery; and

FIG. 6 is a block diagram of an example data backup system for patching of virtual machines during data recovery.

### DETAILED DESCRIPTION

Virtual machines (VMs) may be vulnerable to many of the same issues as physical computing devices, for example, functional bugs_{;} viruses, malware, etc. Therefore, VMs may need to be patched and maintained in a similar manner to physical computing devices. For various reasons, VMs may be offline frequently, e.g., more frequently than physical computing devices. Thus. keeping VMs up to date (i.e., patched) may be challenging.

Some approaches to patching VMs include, for each VM, bringing the VM online, patching/updating the VM, and taking the VM back offline. Such tasks may be performed on various VMs periodically (e.g., whenever new patches are available) such that. VMs are updated and ready when they are to be brought online and used. However; performing these tasks may be time consuming and resource intensive, and performing these tasks may be a waste of time if there is no intention to use the VMs at the current time. Some approaches to patching a VM include updating the VM without bringing the VM online, for example, by updating the raw sectors of the VM image file. These approaches do not address patching the VM at a strategic time related to when the VM is actually likely to be used, for example, during data recovery. Nor do these approaches address patching the VM by communicating with or integrating with a data backup manager.

VMs are commonly backed up, e.g., in a data backup repository. Such backed up VMs may need to be patched or updated before they are restored and used, especially if a large amount of time has passed since they were backed up. Updating such VMs while they reside in the data backup repository may be complex and inefficient. For example, such an update approach may involve updating various backup catalogs, which may be particularly complex if various VMs have been backed up across different sessions.

The present disclosure describes patching of virtual machines during data recovery. The present disclosure describes patching the VM at a strategic time related to when the VM is actually likely to be used (e.g., after/during restore/recovery). Patching a VM when it is likely to be used may save time and resources. The present disclosure describes a VM patching approach where a data backup manager may initiate and/or orchestrate the patching process on a virtualization system, and where the data backup manager may stay apprised of the patching process. In some examples, the data backup manager may communicate with various tools (e.g., mounting tools, patching tools, etc.) of the virtualization system to perform the patching.

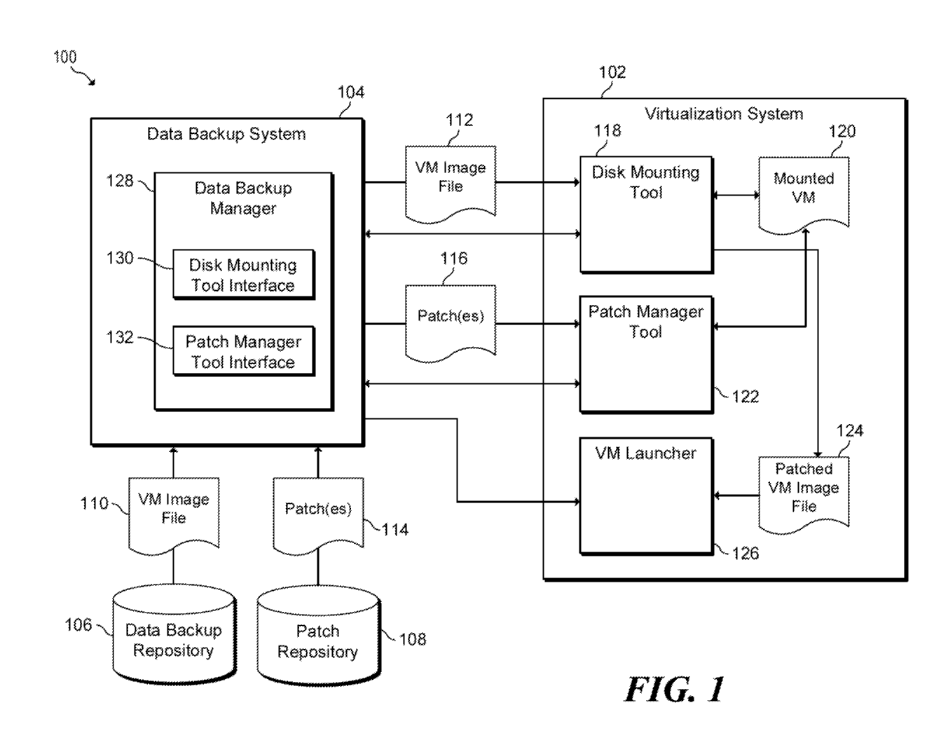

FIG. 1 is a block diagram of an example computing environment 100 in which patching of virtual machines during data recovery may be useful. Computing environment 100 may include a virtualization system 102, a data backup system 104, a data backup repository 106 and a patch repository 108. In various other examples of the present disclosure, a computing environment may include more than one virtualization system, more than one data backup system, more than one data backup repository and/or more than one patch repository. The example of FIG. 1 is described with reference to just one of each of these components; however, in examples with additional components, the additional components may be similar to the components described in FIG. 1.

In the example of FIG. 1, virtualization system 102 may be in communication with data backup system 104, for example, via a network. Such a network may be any wired or wireless network, and may include any number of hubs, routers, switches or the like. Such a network may be, for example, part of the internet, part of an intranet and/or other type of network. Virtualization system 102 may communicate with data backup system 104 to restore (to system 102) a virtual machine (VM) that was previously backed up (e.g., in data backup repository 106). Data backup system 104, as part of a VM restore or recovery, may assist virtualization system 102 in locating a backed up VM, and in some examples, may provide the backed up VM to virtualization system 102. Data backup system 104 may cause the backed up VM to be placed on virtualization system 102, and then data backup system may inform virtualization system 102 that the VM has been restored. Data backup system 104 may then initiate various routines and/or tools on virtualization system 102 to patch or update the restored VM, as will be described in more detail below.

Data backup system 104 may be in communication with at least one data backup repository (e.g., 106), for example, via a network. Such a network may be any wired or wireless network, similar to the network described above. Data backup system 104 may cause data (e.g., a VM image file) to be sent to data backup repository 106 to store the data. Data backup system 104 may, at a later time, cause the data (e.g., a VM image file) to be retrieved from data backup repository 106 to restore the data. Data backup system 104 may, for example, indicate to a virtualization system (e.g., 102) the location (e.g., URL, URI, IF address, network address, etc.) of a VM image file, and the virtualization system may download the file. Alternatively, data backup system 104 may retrieve the VM image file from data backup repository 106, and in turn send it to virtualization system 102.

Data backup repository 106 may be a data store that stores digital information (e.g., backed up VMs as VM image files). Data backup repository 106 may include or be in communication with at least one physical storage mechanism (e.g., hard drive, solid state drive, tap drive or the like) capable of storing such digital information. Data backup repository 106 may include a computing device (e.g., with a processor and system memory) and/or other circuitry to facilitate storage and retrieval of data. In some examples, data backup repository 106 may be included in data backup system 104.

Referring again to the computing environment 100 of AG. 1, data backup system 104 may be in communication with at least one patch repository (e.g., 108), for example, via a network. Such a network may be any wired or wireless network, similar to the networks described above. Data backup system 104 may cause patches (e.g., single patches or bundles of patches) to be retrieved from patch repository 108. Data backup system 104 may, for example, indicate to a virtualization system (e.g., 102) the location (e.g., URL, URI, IP address, network address, etc.) of at least one patch, and the virtualization system may download the patch(es). Alternatively, data backup system 104 may retrieve the patch(es) from patch repository 108, and in turn send the patch(es) to virtualization system 102.

Patch repository 108 may be a data store that stores digital information. Patch repository 108 may include or be in communication with at least one physical storage mechanism (e.g., hard drive, solid state drive, tap drive or the like) capable of storing such digital information. Patch repository 108 may include a computing device (e.g., with a processor and system memory) and/or other circuitry to facilitate storage and retrieval of patches.

The following will provide more information regarding the meaning of a VM image file (e.g., such as is referred to by reference numbers 110, 112). The term “VM image file” or “virtual machine image file” may refer to a file formatted to represent a virtual hard disk drive (e.g., for a virtual machine). The VM image file may contain information that is similar to information that may be found on a physical hard disk drive, such as disk partitions, a file system, files and folders. In other words, the VM image file may abstract the physical disk. A VM image file can be mounted and updated by a computing device without the source VM being brought online. Different computing vendors (e.g., Microsoft, VMware, etc.) may have their own VM image file types. For example, for Microsoft, a virtual machine image file may be referred to as a “virtual hard disk” (VHD). Likewise, for VMware, a virtual image file may be referred to as a “virtual machine disk” (VMDK).

A VM image file may represent a computing machine with a particular operating system installed thereon. For example, one VM image file may relate to a Windows machine (or Windows virtualization solution), and another VM image file may refer to a Linux machine (or Linux virtualization solution). The present disclosure describes an approach to patching of virtual machines irrespective of the virtualization solution used. In other words, the approach of the present disclosure may support patching of VM image files that implement various virtualization solutions. Various descriptions below may refer to two or more alternatives (e.g., Windows and Linux), but it should be understood that additional virtualization solutions can be supported, and the description of only two example virtualization solutions should in no way be construed as limiting.

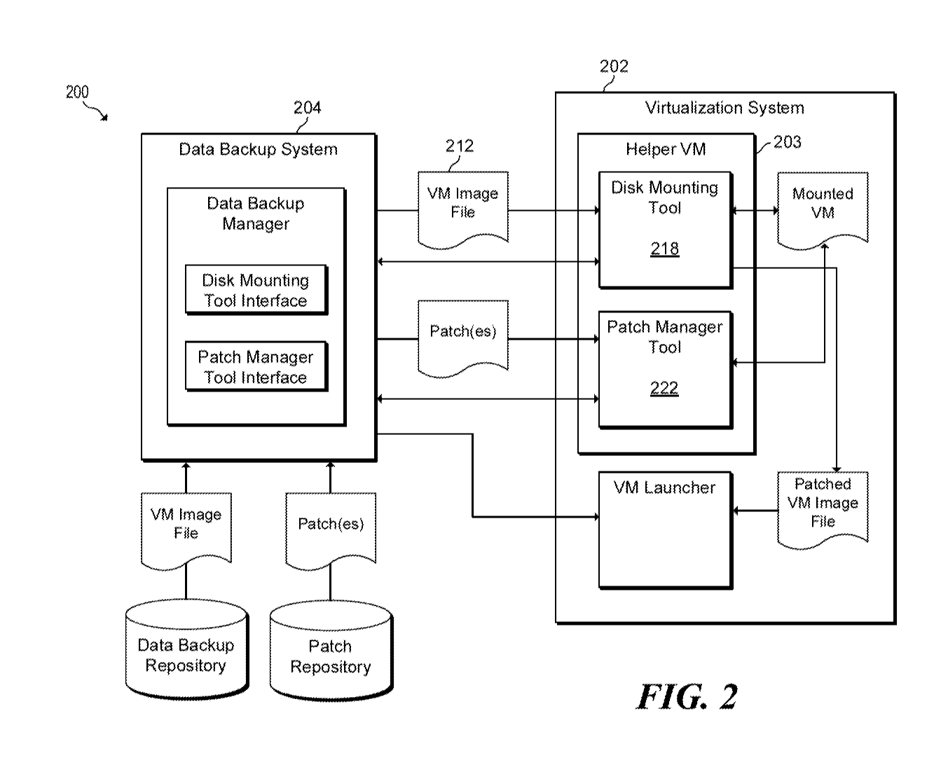

Virtualization system 102 may run a number of virtual machines (VMS), for example, such that client computing devices external to virtualization system 102 can access and use the virtual machines, or such that a direct user of virtualization system 102 can access and use the virtual machines. Virtualization System 102 may be at least one computing device that is capable of running at least one virtual machine and capable of communicating with a data backup system (e.g., 104) over a network. The term “system” may be used to refer to a single computing device or multiple computing devices that operate together to provide a service. Virtualization system 102 may run a particular operating system (e.g., Windows, Linux or the like). The example of FIG. 1 shows an example where the operating system of virtualization system 102 and the operating system of a VM to be restored (e.g., from file 112) are the same or compatible (e.g., both are Windows or both are Linux). FIG. 2, as will be described more below, shows an example where the operating system of virtualization system 102 and the operating system of a VM to be restored are not compatible (e.g., one is Windows and the other is Linux).

In the example of FIG. 1, virtualization system 102 may include a disk mounting tool 118, a patch manager tool 122, and a VM launcher 126. Each of these components may include instructions (e.g., stored on a machine-readable storage medium of system 102) that, when executed (e.g., by a processor of system 102), implement the functionality of the particular component as described herein. Alternatively or in addition, each of these components may include electronic circuitry (i.e., hardware) that implements the functionality of the particular component as described herein.

Disk mounting tool 118 may be a tool used to manage disk partitions. For example, in a Windows-based virtualization system, disk mounting tool 118 may be similar to DISKPART. Disk mounting tool 118 may be capable of accessing the disk structure of a VM image file (e.g., 112) and may be capable of unpacking the VM image file. Such unpacking may be referred to as “mounting” the VM, and may result in a mounted VM (e.g., 120). As mentioned above, a VM image file may be mounted without the source VM being brought online. When a VM has been mounted but is not yet online, this may mean that the operating system of the VM is not yet accessible or available to clients, but the components of the VM may be unpackaged and installed on the virtualization system, and ready to run. Thus, when a VM is mounted, bringing the VM online may be done quickly. Moreover, when a VM is mounted, most or all of the components of the VM may be accessible by the virtualization system such that changes may be made (e.g., by a patch).

Thus, in operation, virtualization system 102 may receive a VM image file (e.g., 112), for example, as part of a VM restore procedure orchestrated by data backup system 104. Virtualization system 102 may receive the VM image file (e.g., 112) from data backup system 104, e.g., after data backup system 104 retrieved the VM image file (e.g., 110) from data backup repository 106. Alternatively, virtualization system 102 may receive the VM image file directly from data backup repository 106 (e.g., based on an indication from data backup system 104 of the location of the VM image file). Then, disk mounting tool 118 may mount the VM, by accessing the VM image file (e.g., 112). The result may be a mounted VM 120.

Disk mounting tool 118 may communicate with data backup system 104 (e.g., with data backup manager 128 and disk mounting tool interface 130), for example, to receive instructions from data backup system 104. Such instructions may include, for example, an indication of where the restored VM image file is stored on virtualization system 102 and an indication that disk mounting tool 118 should mount the VM. Disk mounting tool 118 may also send status information to data backup system 104 (e.g., to data backup manager 128), for example, information indicating that the VM mounting has completed. In this respect, data backup system 104 may stay apprised of the VM mounting process, which may be part of the overall VM patching process, as described herein.

Patch manager tool 122 may be a tool to apply patches or updates to various components (e.g., mounted VM 120) of virtualization system 102. In some examples, e.g., for a Windows-based virtual machine, patch manager tool 122 may be a standalone patch management tool, for example, similar to DISM (Deployment Image Servicing and Management). In other examples, e.g., for a Linux-based virtual machine, patch manager tool 122 may refer to the use of run-level scripts to apply patches or updates.

Thus, in operation, patch manager tool 122 may receive at least one patch (e.g., 116), for example, as part of a VM restore procedure orchestrated by data backup system 104. Virtualization system 102 may receive the patch(es) (e.g., 116) from data backup system 104, e.g., after data backup system 104 retrieved the patch(es) (e.g., 114) from patch repository 108. Alternatively, virtualization system 102 may receive the patch(es) directly from patch repository 108 (e.g., based on an indication from data backup system 104 of the location of the patch(es)). Then, patch manager tool 122 may apply the patch(es) to the mounted VM 120.

Patch manager tool 122 may communicate with data backup system 104 (e.g., with data backup manager 128 and patch manager tool interface 132), for example, to receive instructions from data backup system 104. Such instructions may include, for example, an indication of were the mounted VM (e.g., 120) is located on virtualization system 102 and where the patch(es) are located, for example, in data backup repository 106. Such instructions may also include an indication that patch manager tool should patch the mounted VM using the indicated patches. Patch manager tool 122 may also send status information to data backup system 104 (e.g., to data backup manager 128), for example, information indicating that the VM patching has completed. In this respect, data backup system 104 may stay apprised of the VM patching process.

As mentioned above, in some examples, e.g., for Linux-based virtual machines, patch manager tool 122 may refer to the use of run-level scripts to apply patches or updates. In these scenarios, run-level scripts may be used to point to patch install scripts, such that the patch install scripts apply the patch(es) to the mounted VM (e.g., 120). In some examples, run-level scripts may be automatically run by a VM when the VM is booted into a particular run level. For example, in Linux-based systems, one particular run level (e.g., run level 4) may be related to a user-definable run level, where particular run level scripts (that are modifiable by a user) may be run when the VM is booted into that particular run level. Such run level scripts may be modified to insert a call to patching scripts. The patching scripts may cause the patch(es) to be applies to the mounted VM (e.g., 120).

Thus, in operation, the patching scripts may be copied (e.g., by data backup system 104, data backup manager 128, patch manager tool interlace 132, etc.) to virtualization system 102, and particular run level scripts may be modified (e.g., by data backup system 104, data backup manager 128, patch manager tool interface 132, etc.) such that the run level scripts call the patching scripts. Then, the mounted VM (e.g., 120) may be booted (e.g., by data backup system 104, data backup manager 128, patch manager tool interface 132, etc.) into a user-definable run level (e.g., run level 4). The boot process may then automatically call the modified run level scripts, and in turn, the patching scripts may be called and the mounted VM (e.g., 120) may be patched. At some point, the patching scripts may perform a “clean up” routine, for example, to remove call in the run level scripts to the patching scripts such that the run level scripts do not call the patching scripts again if the VM is again booted into the user defined run level. Once the patches are applied, the mounted VM may be rebooted (e.g., by data backup system 104, data backup manager 128, patch manager tool interface 132, etc.), for example, such that the patches are applied correctly. At some point, the mounted VM may be booted (e.g., by data backup system 104, data backup manager 128, patch manager tool interface 132, etc.) into an originally intended run level (e.g., run level 5 for Linux).

The term “boot” may refer to the process of starting the mounted VM, but where the VM is still short of being “online” (e.g., where the operating system is fully accessible to clients or users). A booted VM has limited capabilities when compared to an online VM. A benefit of booting the VM short of an online state is that run level scripts may be used, which require the VM to be started, without yet allowing clients or users to use the VM.

In the examples where run-level scripts are used to apply patches or updates, virtualization system 102 (e.g., patch manager tool 122), may communicate with data backup system 104 (e.g., with data backup manager 128, patch manager tool interface 132, etc.), for example, to receive data and instructions from data backup system 104. Such data may include, for example, patching scripts and potentially modified run level scripts, as described above. Such instructions may include indications of changes to be made to run level scripts on virtualization system 102. Such instructions may include boot commands, for example, to boot a mounted VM (e.g., 120) into various boot levels and/or to reboot the VM.

Disk mounting tool 118 may in some examples, generate a new VM image file (e.g., patched VM image file 124). For example, after the patching routines described above, mounted VM 120 may be patched or up to date. Then, disk mounting tool 118 may “unmount” or repackage the VM into a new VM image file.

VM Launcher 126 may bring the patched VM online, for example, in response to an indication from data backup system 104 (e.g., data backup manager 128). As mentioned above, data backup system 104 (e.g., data backup manager 128) may monitor the progress of the VM patching process, and may indicate to the VM launcher when the VM is ready to be brought online.

FIG. 2 is a block diagram of an example computing environment 200 in which patching of virtual machines during data recovery may be useful. Computing environment 200 is similar to computing environment 100. Accordingly, each component of computing environment 200 that is similarly named and depicted as a corresponding component in computing environment 100 should be considered similar, except where otherwise specified. Whereas FIG. 1 shows an example where the operating system of virtualization system 102 and the operating system of a VM to be restored (e.g., from file 112) are the same or compatible (e.g., both are Windows or both are Linux), FIG. 2 shows an example where the operating system of virtualization system 202 and the operating system of a VM to be restored (e.g., from file 212) are not compatible (e.g., one is Windows and the other is Linux).

In the example of FIG. 2, virtualization system 202 includes a helper VM 203. Helper VM 203 may have installed thereon, an operating system that is the same as or compatible with the VM to be restored (e.g., from file 212). Thus, for example, if the VM to be restored is Linux-based, the operating system of helper VM 203 may be compatible (e.g., also Linux-based). Likewise, if the VM to be restored is Windows-based, the operating system of helper VM 203 may be compatible (e.g., also Windows-based). Such a helper VM may be useful, for example, because if the operating system of the virtualization system 202 is not compatible with the operating system of the VM to be restored, the virtualization system 202 may be unable to read the file format for the VM image file. For example, Windows may be unable to read a Linux-compatible VM image file.

Helper VM 203 may be running on virtualization system 202 such that it is ready to help with mounting and patching particular VMs. Helper VM 203 may include (e.g., have running thereon) a disk mounting tool 218 and a patch manager tool 222. These tools 218, 222 may be similar to tools 118, 122 shown in FIG. 1 and described in detail above. Helper VM 203 may include instructions (e.g., stored on a machine-readable storage medium of system 202) that, when executed (e.g., by a processor of system 202), implement the functionality of the helper VM 203 as described herein. Alternatively or in addition, helper VM 203 may include electronic circuitry (i.e., hardware) that implements the functionality of the helper VM 203 as described herein.

Referring again to FIG. 1 (although the following description may apply similarly to FIG. 2), data backup system 104 may be at least one computing device that is capable of running a data backup manager (e.g., 128) and capable of communicating with a virtualization system (e.g., 102), a data repository (e.g., 106) and a patch repository (e.g., 108) over at least one network. The term “system” may be used to refer to a single computing device or multiple computing devices that operate together to provide a service. In the example of FIG. 1, data backup system 104 includes a data backup manager 128. Data backup manager 128 may include a disk mounting tool interface 130 and a patch manager tool interface 132.

Data backup manager 128 (and by inclusion, disk mounting tool interface 130 and patch manager tool interface 132) may each include instructions (e.g., stored on a machine-readable storage medium of system 104) that, when executed (e.g., by a processor of system 104), implement the functionality of the particular component as described herein. Alternatively or in addition, each of these components may include electronic circuitry (i.e., hardware) that implements the functionality of the particular component as described herein.

Data backup manager 128 may manage the process of backing up data (e.g., to data backup repository 106) and restoring data (e.g., from repository 106). Data backup manager 128 may serve as a middle man or conduit for data between various systems (e.g., 102) and data backup repository 106, or data backup manager 128 may alternatively coordinate the direct communication of data between various systems (e.g., 102) and data backup repository 106. Data backup manager 128 may perform various VM patching routines, e.g., as part of backing up and/or restoring a VM image file. Data backup manager 128 may initiate various patching routines to take place on other systems (e.g., 102) and may monitor those patching routines and provide ongoing instruction to those patching routines. Thus, the use of such a data backup manager to initiate and manage such VM patching makes the task of automating VM backup possible. In the example of FIG. 1, data backup manager 128 includes a disk mounting tool interface 130 and a patch manager tool interface 132.

Disk mounting tool interface 130 may communicate with at least one disk mounting tool (e.g., 118) of virtualization system 102. For example, disk mounting tool interface 130 may communicate with disk mounting tool 118 to provide various instructions, such as the instructions mentioned above by way of the description of disk mounting tool 118. Disk mounting tool interface 130 may also receive status information from disk mounting tool 118, for example, information indicating that the VM mounting has completed.

Patch manager tool interface 132 may communicate with at least one patch manager tool (e.g., 122) of virtualization system 102. For example, disk mounting tool interface 130 may communicate with patch manager tool 122 to provide various pieces of data and instructions, such as the data and instructions mentioned above by way of the description of patch manager tool 122. Patch manager tool interface 132 may also receive status information from patch manager tool 122, for example, information indicating that the VM patching has completed.

Patch manager tool interface 132 may determine which patches are to be used to patch the VM. For example, only patches that update the target VM beyond its current state (e.g., in repository 106) may be used. In other words, if the backed up VM was previously updated up to a certain point, only subsequent patches may need to be installed. Patch manager tool interface 132 may make this determination of which patches to use based on information related to the VM image file in the data backup repository. For example, patch manager tool 132 may access data backup repository 106 or an internal backup catalog to access a timestamp that indicates when the target VM was last patched. Then, patch manager tool 132 may compare this last-patched timestamp to timestamps related to various patches (e.g., in patch repository 108). Thus, the last-patched timestamp can be used to filter out earlier patches. In some examples, the timestamp routine just described may be simplified and/or automated by patch manager tool interface 132 communicating with a patch manager tool (e.g., 122) where the patch manger tool may easily provide relevant patches based on a provided last-patched timestamp. In some examples, patch manager tool 132 may access data backup repository 106 or an internal backup catalog to access a patch version that indicates when the version of the last patch that was applied to the target VM. Then, patch manager tool 132 may compare this patch version patch versions of various patches (e.g., in patch repository 108). One again, such a process may be simplified by communicating with a patch manager tool (e.g., 122) to receive relevant patches based on a provided last-patch version.

In some situations, patch manager tool interface 132 may determine which patches are to be used to patch the VM based on user configuration. For example, a user (e.g., administrator) of data backup system may specify certain patches that should be applied to a target VM, or certain criteria that should be used to determine which patches should be installed. Patch manager tool interface may use this configuration information to select relevant patches.

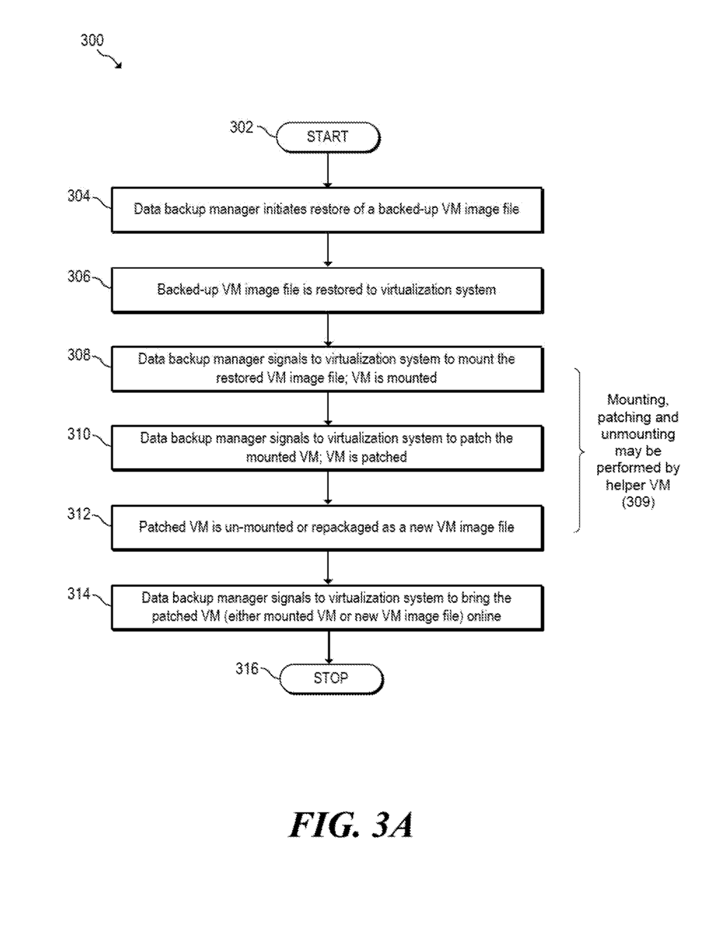

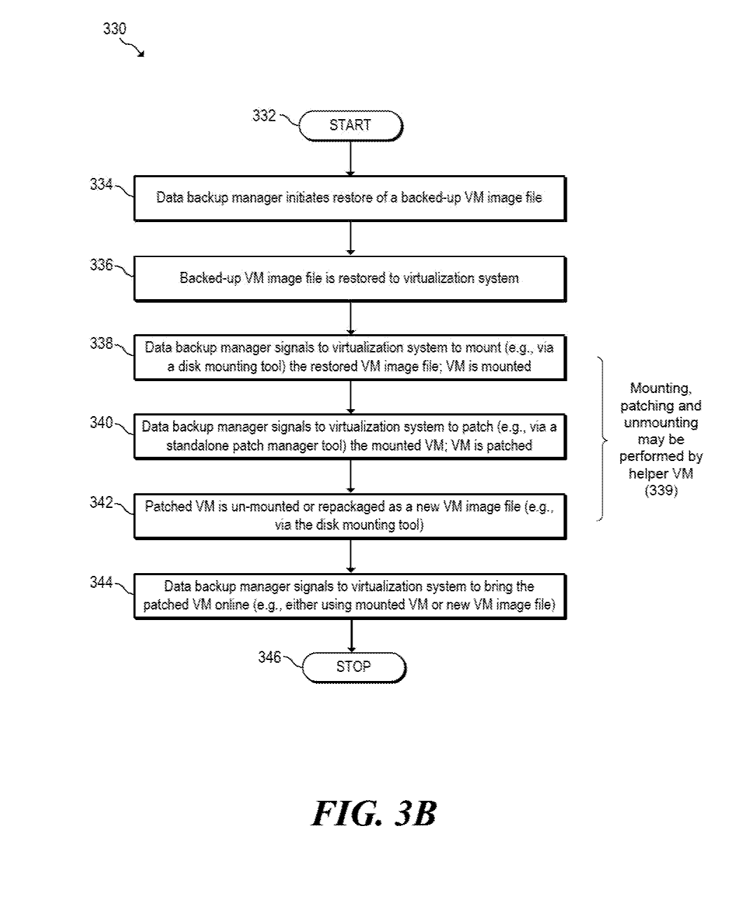

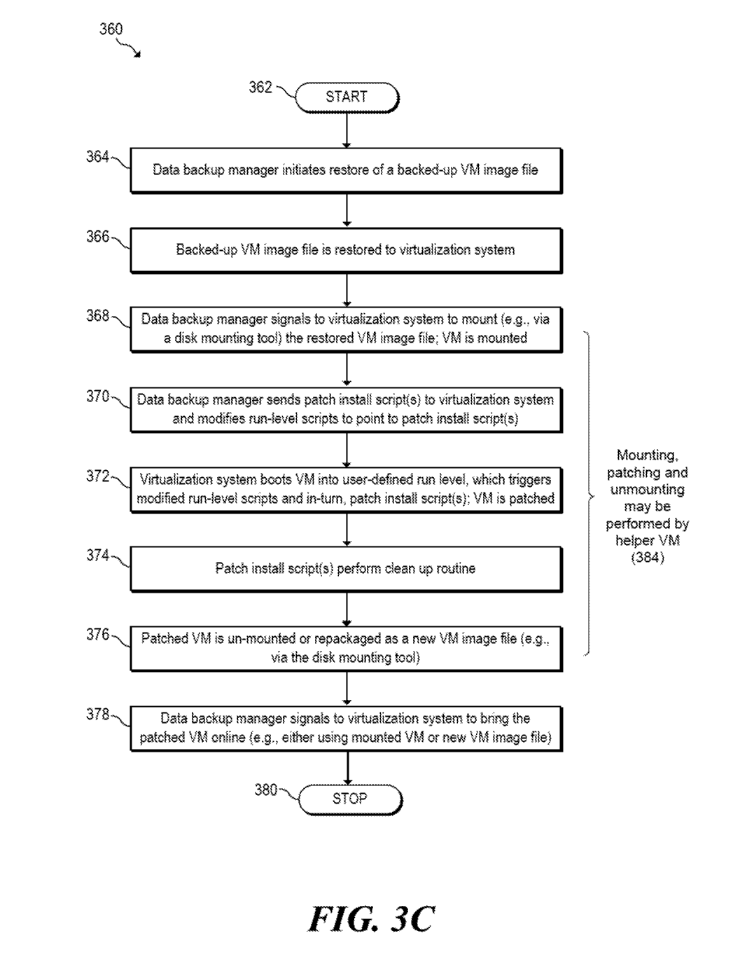

FIGS. 3A, 3B, 3C are flowcharts of example methods (300, 330, 360 respectively) for patching of virtual machines during data recovery. These methods may be described below as being executed or performed by at least one system or computing device, for example, systems 102 and 104 of FIG. 1 or systems 202 and 204 of FIG. 2. Other suitable computing devices or systems may be used as well, for example, system 600 shown in FIG. 6. Each of these methods may be implemented in the form of executable instructions stored on at least one machine-readable storage medium (e.g., of system 102 and/or system 104, or of system 202 and/or system 204), and/or in the form of electronic circuitry. For each of these methods, in alternate embodiments, one or more steps of the method may be executed substantially concurrently or in a different order than shown in the accompanying figure. For each of these methods, in alternate embodiments, the method may include more or less steps than are shown in the accompanying figure. For each of these methods, in some embodiments, one or more of the steps of the method may, at certain times, be ongoing and/or may repeat.

Method 300 (FIG. 3A) is a general approach for patching of virtual machines during data recovery. Method 300 may start at step 302 and continue to step 304, where a data backup manager (e.g., 128) may initiate a restore or recovery of a backed-up VM image file. At step 306, the backed up image file may be restored to a virtualization system (e.g., 102). At step 308, the data backup manager may signal to the virtualization system that it is to mount the restored VM image file, e.g., by indicating the location of the saved VM image file. The virtualization system may then mount the VM image file. At step 310, the data backup manager may signal to the virtualization system that it is to patch the mounted VM, e.g., by indicating the location of the mounted VM and the location of at least one patch to be applied. The virtualization system may then patch the mounted VM. At step 312, the virtualization system may un-mount or repackage the patched VM to a new VM image file. In some examples, as indicated by reference number 309, a helper VM may be running on the virtualization system and may handle the mounting (in step 308), the patching (in step 310) and the un-mounting (in step 312). At step 314, the data backup manager may signal to the virtualization system that the patched VM can be brought online. The virtualization system may use the patched, mounted VM or a newly created VM image file to bring the patched VM online. Method 300 may eventually continue to step 316, where method 300 may stop.

Method 330 (FIG. 3B) is another approach for patching of virtual machines during data recovery, for example, an approach that may be used for patching Windows-based virtual machines. Method 330 may be similar to method 300 in many respects. Method 330 may start at step 332 and continue to step 334, where a data backup manager (e.g., 128) may initiate a restore or recovery of a backed-up VM image file. At step 336, the backed up image file may be restored to a virtualization system (e.g., 102). At step 338, the data backup manager may signal to the virtualization system that it is to mount (e.g., via a disk mounting tool such as 118) the restored VM image file. The virtualization system may then mount (e.g., via a disk mounting tool such as 118) the VM image file. At step 340, the data backup manager may signal to the virtualization system that it is to patch (e.g., via a standalone patch manager tool such as 122) the mounted VM. The virtualization system may then patch (e.g., via a standalone patch manager tool such as 122) the mounted VM. At step 342, the virtualization system may un-mount or repackage the patched VM to a new VM image file (e.g., via the disk mounting tool). In some examples, as indicated by reference number 339, a helper VM may be running on the virtualization system and may handle the mounting (in step 338), the patching (in step 340) and the un-mounting (in step 342). At step 344, the data backup manager may signal to the virtualization system that the patched VM can be brought online. The virtualization system may use the patched, mounted VM or a newly created VM image file to bring the patched VM online. Method 330 may eventually continue to step 346, where method 330 may stop.

Method 360 (FIG. 3C) is another approach for patching of virtual machines during data recovery, for example, an approach that may be used for patching Linux-based virtual machines. Method 360 may be similar to method 300 in many respects. Method 360 may start at step 362 and continue to step 364, where a data backup manager (e.g., 128) may initiate a restore or recovery of a backed-up VM image file. At step 366, the backed up image file may be restored to a virtualization system (e.g., 102). At step 368, the data backup manager may signal to the virtualization system that it is to mount (e.g., via a disk mounting tool such as 118) the restored VM image file. The virtualization system may then mount (e.g., via a disk mounting tool such as 118) the VM image file. At step 370, the data backup manager may send at least one patch install script to the virtualization system, and the backup manager may cause at least one run-level script to be modified to point to the patch install script(s). At step 372, the virtualization system may boot the mounted VM into a user-defined run level as described in detail above. This may trigger the modified run level script(s) which may, in turn, trigger the patch install script(s). Via these scripts, the VM may be patched. At step 374, the patch install script(s) may perform at least one clean up routine, as described above. At step 376, the virtualization system may un-mount or repackage the patched VM to a new VM image file (e.g., via the disk mounting tool). In some examples, as indicated by reference number 384, a helper VM may be running on the virtualization system and may handle the mounting (in step 368), the patching (in steps 370, 372, 374) and the un-mounting (in step 376). At step 378, the data backup manager may signal to the virtualization system that the patched VM can be brought online. The virtualization system may use the patched, mounted VM or a newly created VM image file to bring the patched VM online. Method 360 may eventually continue to step 380, where method 360 may stop.

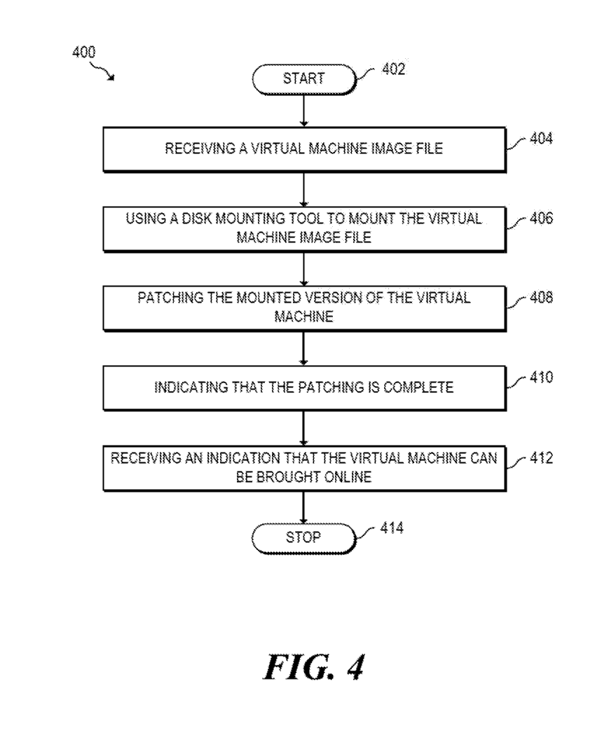

FIG. 4 is a flowchart of an example method 400 for patching of virtual machines during data recovery. Method 400 may be described below as being executed or performed by a system, for example, system 102 of FIG. 1. Other suitable systems or computing devices may be used as well. Method 400 may be implemented in the form of executable instructions stored on at least one machine-readable storage medium of the system, and/or in the form of electronic circuitry. In alternate embodiments of the present disclosure, one or more steps of method 400 may be executed substantially concurrently or in a different order than shown in FIG. 4. In alternate embodiments of the present disclosure, method 400 may include more or less steps than are shown in FIG. 4. In some embodiments, one or more of the steps of method 400 may, at certain times, be ongoing and/or may repeat.

Method 400 may start at step 402 and continue to step 404, where a system (e.g., system 102 of FIG. 1) may receive a virtual machine image file for a virtual machine from a data backup repository. A data backup manager may cause the virtual machine image file to be retrieved from the data backup repository. At step 406, the system may use a disk mounting tool to mount the virtual machine image file to create a mounted version of the virtual machine. At step 408, the system may patch the mounted version of the virtual machine. At step 410, the system may indicate to the data backup manager that the patching is complete. At step 412, the system may receive from the data backup manager an indication that the virtual machine can be brought online. Method 400 may eventually continue to step 414, where method 400 may stop.

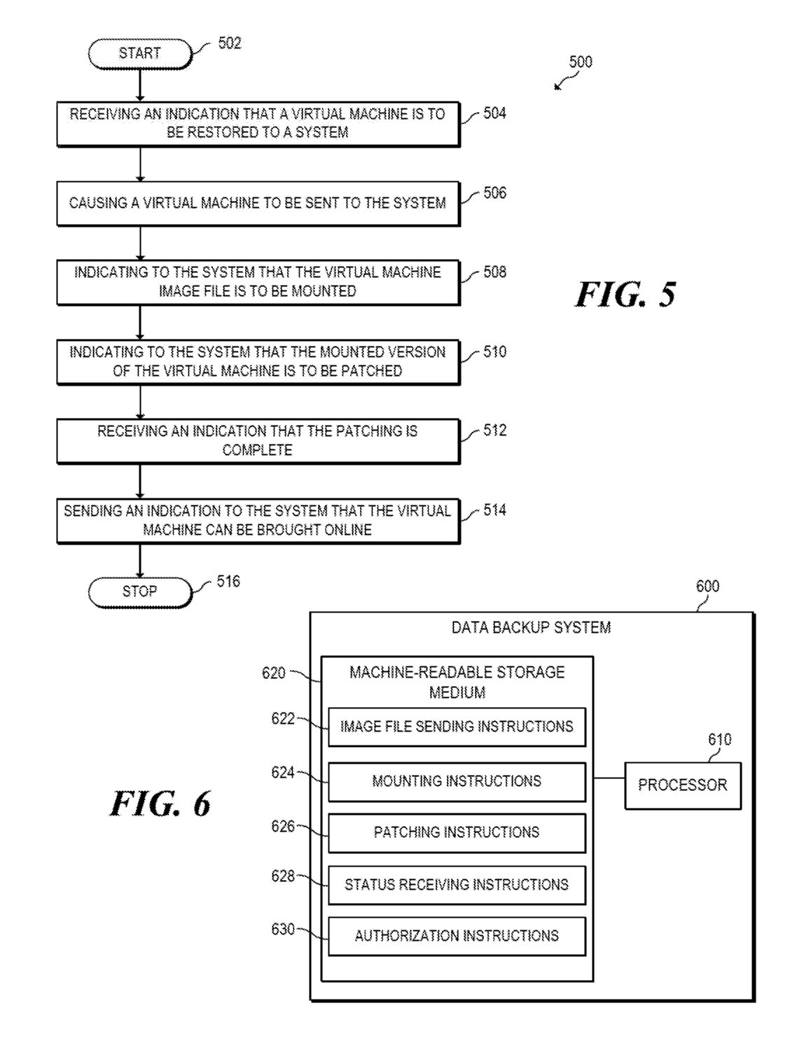

FIG. 5 is a flowchart of an example method 500 for patching of virtual machines during data recovery. Method 500 may be described below as being executed or performed by a system, for example, system 104 of FIG. 1 or system 600 of FIG. 6. Other suitable systems or computing devices may be used as well. Method 500 may be implemented in the form of executable instructions stored on at least one machine-readable storage medium of the system, and/or in the form of electronic circuitry. In alternate embodiments of the present disclosure, one or more steps of method 500 may be executed substantially concurrently or in a different order than shown in FIG. 5. In alternate embodiments of the present disclosure, method 500 may include more or less steps than are shown in FIG. 5. In some embodiments, one or more of the steps of method 500 may, at certain times, be ongoing and/or may repeat.

Method 500 may start at step 502 and continue to step 504, where a system (e.g., 104 of FIG. 1) may receive, at a data backup manager, an indication that a virtual machine is to be restored to a system. At step 506, the system may cause, by the data backup manager, a virtual machine image file for the virtual machine to be sent to the system. The virtual machine image file is retrieved from a data backup repository. At step 508, the system may indicate, by the data backup manager, to the system (e.g., to a disk mounting tool of the system) that the virtual machine image file is to be mounted to create a mounted version of the virtual machine. At step 510, the system may indicate, by the data backup manager, to the system that the mounted version of the virtual machine is to be patched. At step 512, the system may receive, at the data backup manager, an indication from the system that the patching is complete. At step 514, the system may send, by the data backup manager, to the system an indication that the virtual machine can be brought online. Method 500 may eventually continue to step 516, where method 500 may stop.

FIG. 6 is a block diagram of an example data backup system 600 for patching of virtual machines during data recovery. System 600 may be similar to system 104 of FIG. 1, for example. System 600 may be at least one computing device that is capable of running a data backup manager (e.g., similar to 128) and capable of communicating with a virtualization system (e.g., similar to 102), a data repository (e.g., similar to 106) and a patch repository (e.g., similar to 108) over at least one network. In the embodiment of FIG. 6, system 600 includes a processor 610 and a machine-readable storage medium 620.

Processor 610 may be one or more central processing units (CPUs), microprocessors, and/or other hardware devices suitable for retrieval and execution of instructions stored in machine-readable storage medium 620. In the particular embodiment shown in FIG. 6, processor 610 may fetch, decode, and execute instructions 622, 624, 626, 628, 630 to facilitate patching of virtual machines during data recovery. As an alternative or in addition to retrieving and executing instructions, processor 610 may include one or more electronic circuits comprising a number of electronic components for performing the functionality of one or more of instructions in machine-readable storage medium 620. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium. In this situation, the executable instructions may be part of an “installation package”. As described herein, machine-readable storage medium 620 may be encoded with executable instructions for patching of virtual machines during data recovery.

Referring to FIG. 6, image file sending instructions 622, when executed by a processor (e.g., 610), may cause a virtual machine image file for a virtual machine to be sent to a virtualization system (e.g., 102). The virtual machine image file may be retrieved from a data backup repository. mounting instructions 624, when executed by a processor (e.g., 610), may indicate to the virtualization system (e.g., to a disk mounting tool of the virtualization system) that the virtual machine image file is to be mounted to create a mounted version of the virtual machine. Patching instructions 626, when executed by a processor (e.g., 610), may indicate to the virtualization system that the mounted version of the virtual machine is to be patched. Status receiving instructions 628, when executed by a processor (e.g., 610), may receive an indication from the virtualization system that the patching is complete. Authorization instructions 630, when executed by a processor (e.g., 610), may send to the virtualization system an indication that the virtual machine can be brought online.

1. A method for patching a virtual machine during data recovery, the method comprising:
receiving a virtual machine image file for a virtual machine from a data backup repository, wherein a data backup manager caused the virtual machine image file to be retrieved from the data backup repository;
using a disk mounting tool to mount the virtual machine image file to create a mounted version of the virtual machine;
patching the mounted version of the virtual machine;
indicating to the data backup manager that the patching is complete; and
receiving from the data backup manager an indication that the virtual machine can be brought online.

2. The method of claim 1, wherein the patching is performed by a patch manager tool.

3. The method of claim 1, wherein the patching is performed using a patching script and by modifying at least one run level script to call the patching script.

4. The method of claim 1, wherein the disk mounting tool mounts the virtual machine image file in response to a signal from the data backup manager.

5. The method of claim 1, wherein the patching of the mounted version of the virtual machine occurs in response to a signal from the data backup manager.

6. The method of claim 1, wherein the patching of the mounted version of the virtual machine includes receiving a patch from a patch repository, wherein the data backup manager caused the patch to be retrieved from the patch repository.

7. The method of claim 1, further comprising bringing the virtual machine online in response to the indication that the virtual machine can be brought online.

8. A method for patching a virtual machine during data recovery, the method comprising:
receiving, at a data backup manager, an indication that a virtual machine is to be restored to a system;
causing, by the data backup manager, a virtual machine image file for the virtual machine'to be sent to the system, wherein the virtual machine image file is retrieved from a data backup repository;
indicating, by the data backup manager, to the system, to a disk mounting tool of the system, that the virtual machine image file is to be mounted to create a mounted version of the virtual machine;
indicating, by the data backup manager, to the system that the mounted version of the virtual machine is to be patched;
receiving, at the data backup manager, an indication from the system that the patching is complete; and
sending, by the data backup manager, to the system an indication that the virtual machine can be brought online.

9. The method of claim 8, wherein indicating that the mounted version of the virtual machine is to be patched includes indicating to a patch manager tool of the system.

10. The method of claim 8, wherein indicating that the mounted version of the virtual machine is to be patched includes sending a patching script to the system and causing at least one run level script of the system to be modified to call the patching script.

11. The method of claim 8, further comprising causing, by the data backup manager, a patch from a patch repository to be sent to the system, wherein the patch is used for the patching.

12. The method of claim 11, wherein the data backup manager determines the patch by comparing a timestamp that indicates when the virtual machine was last backed up to multiple timestamps respectively related to multiple available patches.

13. A machine-readable storage medium encoded with instructions for patching a virtual machine during data recovery, the instructions executable by a processor of a data backup system, the instructions comprising:
image file sending instructions to cause a virtual machine image file for a virtual machine to be sent to a virtualization system, wherein the virtual machine image file is retrieved from a data backup repository;
mounting instructions to indicate to the virtualization system, to a disk mounting tool of the virtualization system, that the virtual machine image file is to be mounted to create a mounted version of the virtual machine;
patching instructions to indicate to the virtualization system that the mounted version of the virtual machine is to be patched;
status receiving instructions to receive an indication from the virtualization system that the patching is complete; and
authorization instructions to send to the virtualization system an indication that the virtual machine can be brought online.

14. The machine-readable storage medium of claim 13, the instructions further comprising virtual machine helper instructions to run a helper virtual machine with an operating system that is compatible with the operating system of the virtual machine, wherein the helper virtual machine runs the mounting instructions and the patching instructions.

15. The machine-readable storage medium of claim 14, wherein the patching instructions are to send a patching script to the virtualization system and cause at least one run level script of the virtualization system to be modified to call the patching script.
